(19) United States
(12) Patent Application Publication
(10) Pub. No.: US 2019/0382321 A1
(43) Pub. Date: Dec. 19, 2019

(54) ACID-RESISTANT UREASE INHIBITOR ADDUCT-CONTAINING FERTILIZER COMPOSITIONS

(71) Applicant: Koch Agronomic Services, LLC, Wichita, KS (US)

(72) Inventors: Ethel Garnier, Wichita, KS (US); Douglas Barr, Wichita, KS (US)

(21) Appl. No.: 16/479,098

(22) PCT Filed: Jan. 18, 2018
(86) PCT No.: PCT/IB2018/050319

§ 371 Date: Jul. 18, 2019

Related U.S. Application Data
(60) Provisional application No. 62/448,466, filed on Jan. 20, 2017.

(51) Int. Cl. C05G 3/08; C05C 9/00; C05C 9/02

(52) U.S. Cl. CPC C05G 3/08; C05C 9/02; C05C 9/005

(57) ABSTRACT

A urease inhibiting acidic fertilizer composition is provided, the fertilizer composition including urea; one or more adducts of a urease inhibitor with urea, formaldehyde, or both urea and formaldehyde; a particulate acidic fertilizer; and a basic component. Methods of forming and using such fertilizer compositions are also provided herein.

### FIELD OF THE DISCLOSURE

The present subject matter relates generally to compositions comprising urease inhibitors and to methods of preparing and using such compositions.

### BACKGROUND

Fertilizers have been used for some time to provide nitrogen to the soil. The most widely used and agriculturally important nitrogen fertilizer is urea, CO(NH₂)₂. Most of the urea currently produced is used as a fertilizer in its granular (or prilled) form. After application of urea to soil, it is readily hydrolyzed to yield ammonia and carbon dioxide. This process is catalyzed by the enzyme urease, which is produced by some bacteria and fungi that may be present in the soil. The gaseous products formed by the hydrolysis reaction (i.e., ammonia and carbon dioxide) can volatilize to the atmosphere and thus, substantial losses from the total amount of the nitrogen applied to the soil can occur.

Attempts to reduce losses of applied nitrogen have utilized urease inhibitors and/or nitrification inhibitors as additives to the fertilizer. Urease inhibitors are compounds capable of inhibiting the catalytic activity of the urease enzyme on urea in the soil. Nitrification inhibitors are compounds capable of inhibiting the bacterial oxidation of ammonium to nitrate in the soil. Urease inhibitors and nitrification inhibitors can be associated with fertilizers in various ways. For example, they can be coated onto fertilizer granules or mixed into fertilizer matrices. A number of granulation methods are known, including falling curtain, spherudization-agglomeration drum granulation, prilling and fluid bed granulation technologies.

Examples of urease inhibitors are the thiophosphoric triamide compounds disclosed in U.S. Pat. No. 4,530,714 to Kolc et al., which is incorporated herein by reference. The disclosed thiophosphoric triamide compounds include N-(n-butyl) thiophosphoric triamide (NBPT), the most developed representative of this class of compounds. When incorporated into a urea-containing fertilizer, NBPT reduces the rate at which urea is hydrolyzed in the soil to ammonia. The benefits realized as a result of the delayed urea hydrolysis include the following: (1) nutrient nitrogen is available to the plant over a longer period of time; (2) excessive build-up of ammonia in the soil following the application of the urea-containing fertilizer is avoided; (3) the potential for nitrogen loss through ammonia volatilization is reduced; (4) the potential for damage by high levels of ammonia to seedlings and young plants is reduced; (5) plant uptake of nitrogen is increased; and (6) an increase in crop yields is attained. NBPT is commercially available for use in agriculture and is marketed in such products as the A GROT AIN® nitrogen stabilizer product line.

Industrial grade NBPT is a solid, waxy compound, and decomposes by the action of water, acid and/or elevated temperature. In particular, NBPT is believed to degrade under acidic conditions into compounds that may not provide the desired inhibitory effects on the urease enzyme. As such, there is a need for urease inhibitor-containing compositions (e.g., NBPT-containing compositions) that are effective in acidic conditions, e.g., which include combinations of such compositions with acidic fertilizers. It is further desirable to extend the shelf-life of compositions comprising urease inhibitors (e.g., NBPT) and acidic fertilizers.

### SUMMARY OF THE INVENTION

As disclosed herein, compositions comprising urease inhibitors and methods for making such compositions are provided. In various embodiments of the present invention, a urease inhibiting acidic fertilizer composition is provided, the composition comprising: a particulate composition comprising urea and one or more adducts of a urease inhibitor with urea, formaldehyde, or both urea and formaldehyde; a particulate acidic fertilizer; and a basic component. In some embodiments, the particulate acidic fertilizer comprises a plurality of particles each having a surface, and the basic component at least partially coats the surface of at least some of the plurality of particles, such that the particulate acidic fertilizer and the basic component are present in the form of a basic component-treated particulate acidic fertilizer. In certain embodiments, the weight percentage range of the basic component is 0.0001% to 20% by weight, based on the total dry weight of the basic component-treated particulate acidic fertilizer.

In some embodiments, the particulate composition comprising urea and one or more adducts of a urease inhibitor with urea, formaldehyde, or both urea and formaldehyde comprises a plurality of particles each having a surface, and the basic component at least partially coats the surface of each of the plurality of particles, such that the particulate composition comprising urea and one or more adducts of a urease inhibitor with urea, formaldehyde, or both urea and formaldehyde and the basic component are present in the form of a basic component-treated particulate urease inhibiting composition. In certain embodiments, the weight percentage range of the basic component is 0.0001% to 20% by weight, based on the total dry weight of the basic component-treated particulate urease inhibiting composition.

In various embodiments of the present invention, the particulate acidic fertilizer is selected from the group consisting of monoammonium phosphate (MAP), diammonium phosphate (DAP), ammonium sulfate, and ammonium hydrogensulfate, rock phosphate, super phosphate, serpentine super phosphate, reactive phosphate rock, NPSZ, Micro-Essentials® SZ (MESZ (12-40-0-1OS-1Zn)), triple super phosphate, struvite, and any combination thereof.

In some embodiments of the compositions disclosed herein, the basic component comprises: i) an organic carboxylic or a sulfonic acid salt according to Formula (II):

R¹(X⁻)ₙMⁿ⁺ (Formula II)

wherein R¹ is independently hydrogen, substituted or non-substituted C₁-C₃₀ straight or branched alkyl, substituted or non-substituted C₁-C₃₀ straight or branched alkenyl, substituted or non-substituted C₃-C₈ cycloalkyl, or substituted or non-substituted C₅-C₆ aromatic carbon or heterocyclic ring; (X⁻) is a (COO⁻) or (SO₃⁻); Mⁿ⁺ is a metal ion, wherein the metal is Li, Na, K, Rb, Cs, Mg, Ca, Sr, Ba, Ra, Al, Mn, Fe, Co, Cu, or Zn; and n is 1, 2, 3, or 4; ii) a metal oxide, metal hydroxide, metal alkoxide with C₁-C₃₀ straight or branched carbon chain, metal sulfate, metal bisulfate, metal carbonate, or metal bicarbonate, wherein the metal is Li, Na, K, Rb, Cs, Mg, Ca, Sr, Ba, Ra, Al, Mn, Fe, Co, Cu, or Zn; or iii) an amine compound, wherein the amine compound is a primary, secondary, or tertiary, straight or branched hydrocarbon amine, wherein the hydrocarbon is C₁-C₃₀ straight or branched alkyl, C₁-C₃₀ straight or branched alkenyl, C₃-C₈ cycloalkyl, or benzene ring, wherein the hydrocarbon is optionally substituted with hydroxyl, amino, or [(—NH)(CH₂CH₂)]ₓNH₂, wherein x is 1, 2, 3, or 4. In some embodiments, the basic component is selected from the group consisting of ammonium carbonate ((NH4)2CO3), lithium oxide (Li₂O), lithium hydroxide (LiOH), lithium carbonate (Li₂CO₃), barium oxide (BaO), barium hydroxide(Ba(OH)₂, barium carbonate (BaCO₃), magnesium oxide (MgO), magnesium hydroxide (Mg(OH)₂), magnesium carbonate (MgCO₃), calcium oxide (CaO), calcium hydroxide (Ca(OH)₂), calcium carbonate (CaCO₃), aluminum oxide (Al₂O₃), aluminum hydroxide (Al(OH)₃), aluminum carbonate (Al₂(CO₃)₃), sodium oxide (Na₂O), sodium hydroxide (NaOH), sodium carbonate (Na₂CO₃), potassium oxide (K₂O), potassium hydroxide (KOH), potassium carbonate (K₂CO₃), monoethanolamine (MEA), triethylenetetramine (TETA), triethylamine (TEA), diethanolamine, triethanolamine, aniline, and any combination thereof.

In certain embodiments of the compositions described herein, the urease inhibitor comprises N-(n-butyl)thiophosphoric triamide (NBPT). Compositions of the present invention can further comprise one or more materials selected from the group consisting of free NBPT, free formaldehyde, formaldehyde equivalents, urea formaldehyde polymer (UFP), water, and combinations thereof.

The compositions disclosed herein can have an increased shelf-life as compared to a shelf-life of a composition without the basic component. In some embodiments, the increased shelf-life of the urease inhibiting acidic fertilizer compositions described herein is about 25% to about 1000% longer than the shelf-life of similar fertilizer compositions without the basic component. In certain embodiments, the increased shelf-life of the urease inhibiting acidic fertilizer compositions described herein is at least 25% longer than the shelf-life of similar fertilizer compositions without the basic component.

Methods of enhancing shelf life of a composition comprising a urease inhibitor and an acidic fertilizer (such as any of the compositions disclosed herein above) are also provided herein. In various embodiments, the method comprises: providing the urease inhibitor in the form of one or more adducts of urease inhibitor with urea, formaldehyde, or both urea and formaldehyde; and providing the acidic fertilizer in the form of a particulate acidic fertilizer; wherein the particulate acidic fertilizer comprises a plurality of particles each having a surface, and wherein a basic component at least partially coats the surface of at least some of the plurality of particles, such that the particulate acidic fertilizer and the basic component are present in the form of a basic component-treated particulate acidic fertilizer. In some embodiments, the weight percentage range of the basic component is 0.0001% to 20% by weight, based on the total dry weight of the basic component-treated particulate acidic fertilizer.

Methods of making a urease inhibiting acidic fertilizer composition are also provided herein. In various embodiments, the method comprises: providing a particulate composition comprising urea and one or more adducts of a urease inhibitor with urea, formaldehyde, or both urea and formaldehyde; treating a surface of a particulate acidic fertilizer with a basic component to form a basic-treated acidic fertilizer; and combining the particulate composition comprising urea and one or more adducts with the basic-treated acidic fertilizer to form the urease inhibiting acidic fertilizer composition. In some embodiments, the method further comprises combining urea, formaldehyde, and N-(n-butyl)thiophosphoric triamide (NBPT), such that an excess of urea is present, to form the particulate composition comprising urea and one or more adducts, wherein the one or more urease inhibitor adducts comprise one or more adducts represented by the following:

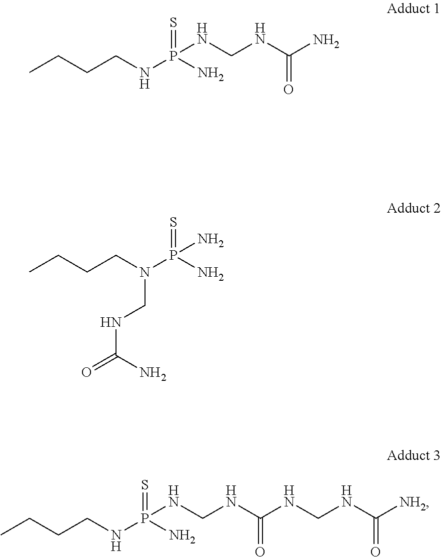 [SMILES: CCCCNP(N)(=S)NCNC(N)=O ; CCCCN(CNC(N)=O)P(N)(N)=S ; CCCCNP(N)(=S)NCNC(=O)NCNC(N)=O]

which adduct or adducts remain incorporated into the excess of urea.

Further, the disclosure provides a composition comprising one or more adduct dimers of NBPT, urea and formaldehyde, wherein the one or more adduct dimers are represented by the following structure:

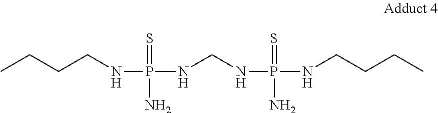 [SMILES: CCCCNP(N)(=S)NCNP(N)(=S)NCCCC]

Methods of fertilizing soil are also provided herein. The method can comprise treating soil with any of the urease inhibiting acidic fertilizer compositions described herein.

### DETAILED DESCRIPTION OF THE INVENTION

It is noted here that as used in this specification and the appended claims, the singular forms “a,” “an,” and “the” include plural reference unless the context clearly dictates otherwise. All percentages, parts and ratios are based upon the total weight of the compositions of the present invention, unless otherwise specified. All such weights as they pertain to listed ingredients are based on the active level and, therefore do not include solvents or by-products that may be included in commercially available materials, unless otherwise specified. The term “weight percent” may be denoted as “wt. %” herein. All molecular weights as used herein are weight average molecular weights expressed as grAS/mole, unless otherwise specified.

In various embodiments of the present invention, economic and stable compositions comprising a urease inhibitor-containing urea source and an acidic fertilizer are provided. In particular, the urease inhibitor-containing urea source comprises a urease inhibitor in the form of a reaction product comprising one or more adducts formed from a urease inhibitor and urea and/or an aldehyde (e.g., formaldehyde) (referred to herein as “urease inhibitor adducts”), as will be described in further detail herein below. Such compositions, comprising one or more urease inhibitor adducts and an acidic fertilizer, can further comprise a basic component, which can serve to at least partially mitigate the negative effects associated with interaction between the acidic fertilizer and acid-sensitive urease inhibitors such as N-(n-butyl) thiophosphoric triamide (NBPT), thereby providing improved storage life for the compositions.

### Urease Inhibitor Adducts and Preparation Thereof

“Urease inhibitor adduct” as used herein refers to a reaction product resulting from reaction between one or more urease inhibitors and urea and/or an aldehyde (e.g., formaldehyde). Such reaction products (comprising one or more structurally different adducts) retain at least portions of two or more of the reactants (i.e., urease inhibitor, urea, and/or formaldehyde). Some urease inhibitor adducts are disclosed in U.S. patent application Ser. No. 15/349,512, filed Nov. 11, 2016, which is incorporated by reference herein in its entirety. One exemplary urease inhibitor adduct, which is not intended to be limiting, is an adduct formed from N-(n-butyl) thiophosphoric triamide (NBPT) and urea, and/or formaldehyde. inhibitor adducts can be provided as-formed, can be purified to isolate one or more components therefrom, or can be provided in combination with one or more components, such as additional urease inhibitor or a fertilizer composition, e.g., in the form of a nitrogen source including, but not limited to, a urea source.

As used herein, the term “urease inhibitor” refers to any compound that reduces, inhibits, or otherwise slows down the conversion of urea to ammonium (NH₄⁺) in soil. Exemplary urease inhibitors include thiophosphoric triamides and phosphoric triamides of the general formula (1):

X=P(NH₂)₂NR¹R² (I)

where X=oxygen or sulfur, and R¹ and R² are independently selected from hydrogen, C₁-C₁₂ alkyl, C₃-C₁₂ cycloalkyl, C₆-C₁₄ aryl, C₂-C₁₂ alkenyl, C₂-C₁₂ alkynyl, C₅-C₁₄ heteroaryl, C₁-C₁₄ heteroalkyl, C₂-C₁₄ heteroalkenyl, C₂-C₁₄ heteroalkynyl, or C₃-C₁₂ cycloheteroalkyl groups.

In certain embodiments, urease inhibitors are N-(alkyl) thiophosphoric triamide urease inhibitors as described in U.S. Pat. No. 4,530,714 to Kolc et al., which is incorporated herein by reference. Particular illustrative urease inhibitors can include, but are not limited to, N-(n-butyl) thiophosphoric triamide, N-(n-butyl)phosphoric triamide, thiophosphoryl triamide, phenyl phosphorodiamidate, cyclohexyl phosphoric triamide, cyclohexyl thiophosphoric triamide, phosphoric triamide, hydroquinone, p-benzoquinone, hexamidocyclotriphosphazene, thiopyridines, thiopyrimidines, thiopyridine-N-oxides, N,N-dihalo-2-imidazolidinone, N-halo-2-oxazolidinone, derivatives thereof, or any combination thereof. Other examples of urease inhibitors include phenylphosphorodiamidate (PPD/PPDA), hydroquinone, N-(2-nitrophenyl) phosphoric acid triamide (2-NPT), ammonium thiosulphate (ATS) and organa-phosphorous analogs of urea, which are effective inhibitors of urease activity (see e.g. Kiss and Simihaian, Improving Efficiency of Urea Fertilizers by Inhibition of Soil Urease Activity. Kluwer Academic Publishers, Dordrecht, The Netherlands, 2002; Watson, Urease inhibitors. IFA International Workshop on Enhanced-Efficiency Fertilizers, Frankfurt. International Fertilizer Industry Association, Paris, France 2005).

In particular embodiments, the urease inhibitor can be or can include N-(n-butyl) thiophosphoric triamide (NBPT). The preparation of phosphoramide urease inhibitors such as NBPT can be accomplished, for example, by known methods starting from thiophosphoryl chloride, primary or secondary amines and ammonia, as described, for example, in U.S. Pat. No. 5,770,771, which is incorporated herein by reference. In a first step, thiophosphoryl chloride is reacted with one equivalent of a primary or secondary amine in the presence of a base, and the product is subsequently reacted with an excess of ammonia to give the end product. Other methods include those described in U.S. Pat. No. 8,075,659, which is incorporated herein by reference, where thiophosphoryl chloride is reacted with a primary and/or secondary amine and subsequently with ammonia. However this method can result in mixtures. Accordingly, when N-(n-butyl)thiophosphoric triamide (NBPT) or other urease inhibitors are used, it should be understood that this refers not only to the urease inhibitor in its pure form, but also to various commercial/industrial grades of the compound, which can contain up to 50 percent (or less), preferably not more than 20 percent, of impurities, depending on the method of synthesis and purification scheme(s), if any, employed in the production thereof. Combinations of urease inhibitors, for example usmg mixtures of NBPT and other alkyl-substituted thiophosphoric triamides, are known.

Representative grades of urease inhibitor may contain up to about 50 wt. %, about 40% about 30%, about 20% about 19 wt. %, about 18 wt. %, about 17 wt. %, about 16 wt. %, about 15 wt. %, about 14 wt. %, about 13 wt. %, about 12 wt. %, about 11 wt. %, 10 wt. %, about 9 wt. %, about 8 wt. %, about 7 wt. %, about 6 wt. % about 5 wt. %, about 4 wt. %, about 3 wt. %, about 2 wt. %, or about 1 wt. % impurities, depending on the method of synthesis and purification scheme(s), if any, employed in the production of the urease inhibitor. A typical impurity in NBPT is PO(NH₂)₃ which can catalyze the decomposition of NBPT under aqueous conditions. Thus in some embodiments, the urease inhibitor used is about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, or about 99.9% pure.

For simplicity, the invention may be described in relation to embodiments wherein NBPT is the urease inhibitor. Description of the invention in terms wherein NBPT is the urease inhibitor should not be viewed as necessarily excluding the use of other urease inhibitors, or combinations of urease inhibitors, unless expressly noted.

The urea used to produce the adducts disclosed herein can be in various forms. For example, the urea can be a solid in the form of prills, flakes, granules, and the like, and/or a solution, such as an aqueous solution, and/or in the form of molten urea. At least a portion of the urea can be in the form of animal waste. Both urea and combined urea-formaldehyde products can be used according to the present disclosure. Illustrative urea-formaldehyde products can include, but are not limited to, urea-formaldehyde concentrate (“UFC”) and urea-formaldehyde polymers (“UFP”). These types of products can be as discussed and described in U.S. Pat. Nos. 5,362,842 and 5,389,716 to Graves et al., for example, which are incorporated herein by reference. Any form of urea or urea in combination with formaldehyde can be used to make a UFP. Examples of solid UFP include PERGOPAK M® 2, available from Albemarle Corporation and NITAMIN 36S, available from Koch Agronomic Services, LLC. Any of these urea sources can be used alone or in any combination to prepare the reaction product disclosed herein.

As referenced hereinabove, in some embodiments, the aldehyde (e.g., formaldehyde) used as a reagent to produce the reaction products disclosed herein can be provided in combination with the urea (e.g., in the form of a mixture or polymer with urea). In such embodiments that use formaldehyde, additional formaldehyde need not be added to form the desired adduct, although the disclosure is not limited thereto and it is possible to add additional formaldehyde to such urea-formaldehyde products. Accordingly, although formaldehyde is described herein as a separate, independent reagent to produce the adducts described herein, it is noted that in certain embodiments, formaldehyde equivalents incorporated within the adduct may be already present within the urea source (i.e., the formaldehyde is not intentionally added to the reaction).

In some embodiments, an aldehyde (e.g., formaldehyde) is intentionally added as a reagent to prepare the reaction products disclosed herein, and the aldehyde can be in various forms. For example, if formaldehyde is used, paraform (solid, polymerized formaldehyde) and/or formalin solutions (aqueous solutions of formaldehyde, sometimes with methanol, in about 10 wt. %, about 20 wt. %, about 37 wt. %, about 40 wt. %, or about 50 wt. %, based on the weight of the formalin solution) are commonly used forms of formaldehyde. In some embodiments, the formaldehyde can be an aqueous solution having a concentration of formaldehyde ranging from about 10 wt. % to about 50 wt. % based on total weight of the aqueous solution. Formaldehyde gas can also be used. Formaldehyde substituted in part or in whole with substituted aldehydes such as acetaldehyde and/or propylaldehyde can also be used as the source of formaldehyde. Any of these forms of aldehyde sources can be used alone or in any combination to prepare the reaction product described herein.

The method of preparing the reaction products (and particularly, urease inhibitor adducts) disclosed herein can vary. Generally, the urease inhibitor (e.g., NBPT) is combined with, mixed, or otherwise contacted with urea and formaldehyde. For example, at least a portion of the urease inhibitor (e.g., NBPT) can react with at least a portion of the urea and/or at least a portion of the formaldehyde to form one or more structurally different adducts, as will be described further hereinafter.

The reactants (i.e., urea, formaldehyde, and NBPT) can be combined with one another in any order or sequence. For example, in one embodiment, urea and formaldehyde are first combined and the urease inhibitor (e.g., NBPT) is added thereto. In another embodiment, urea and a urea formaldehyde product (e.g., urea formaldehyde concentrate or urea-formaldehyde polymer) are combined and the urease inhibitor (e.g., NBPT) is added thereto. In a further embodiment, a urea formaldehyde product and formaldehyde are combined and the urease inhibitor (e.g., NBPT) is added thereto. In a still further embodiment, urea and the urease inhibitor (e.g., NBPT) are combined and formaldehyde or a urea formaldehyde product is added thereto. Additionally, in certain embodiments, other components can be included at any of these stages, alone, or in combination with the urea, formaldehyde, or urease inhibitor (e.g., NBPT). For example, in some embodiments, a nitrification inhibitor (such as those disclosed herein below) can be combined with one or more of the components, e.g., including but not limited to, embodiments wherein the nitrification inhibitor is combined with the urease inhibitor (e.g., NBPT) and this mixture is combined with the other components.

In these various embodiments, the form of the urease inhibitor (e.g., NBPT) added can vary. For example, the urease inhibitor (e.g., NBPT) can be used in molten liquid form, in solution form, or in suspension/dispersion form. Similarly, the form of the material with which the urease inhibitor (e.g., NBPT) is combined (i.e., the urea/formaldehyde mixture, the urea/urea formaldehyde product mixture, or the urea formaldehyde product/formaldehyde mixture) can vary. For example, in some embodiments, the material with which the urease inhibitor (e.g., NBPT) is combined can be in solution form, can be in dispersion/suspension form, or can be in the form of a molten urea liquid. In either case, the form of the urease inhibitor, urea, and formaldehyde should allow for a high degree of contact between the reagents to facilitate the reaction and formation of adducts.

Where solvents are used at any stage of the combining process, the solvents employed are generally those sufficient to solubilize one or more of the urease inhibitor (e.g., NBPT), urea, and/or formaldehyde. Suitable solvents can include, for example, water (including aqueous buffers), N-alkyl 2-pyrrolidones (e.g., N-methyl 2-pyrrolidone), glycols and glycol derivatives, ethyl acetate, acetonitrile, propylene glycol, benzyl alcohol, and combinations thereof. Representative solvents known to solubilize NBPT include, but are not limited to, those solvents described in U.S. Pat. Nos. 5,352,265 and 5,364,438 to Weston, 5,698,003 to Omilinsky et al., 8,048,189 and 8,888,886 to Whitehurst et al., WO2014/100561 to Ortiz-Suarez et al., WO2014/055132 to McNight et al., WO2014/028775 and WO2014/028767 to Gabrielson et al., and EP2032589 to Cigler, which are incorporated herein by reference. In certain embodiments, the solvent, or mixture of solvents, employed to combine the components can be selected from the group consisting of water (including buffered solutions, e.g., phosphate buffered solutions), glycols (e.g., propylene glycol), glycol derivatives and protected glycols (e.g., glycerol including protected glycerols such as isopropylidine glycerol, glycol ethers e.g. monoalkyl glycol ethers, dialkyl glycol ethers), acetonitrile, DMSO, alkanolamines (e.g., triethanolamine, diethanolamine, monoethanolamine, alkyldiethanolamines, dialkylmonoethanolamines, wherein the alkyl group can consist of methyl, ethyl, propyl, or any branched or unbranched alkyl chain), alkylsulfones e.g., sulfolane), alkyl amides (e.g., N-methyl 2-pyrrolidone, N-ethyl 2-pyrrolidone, N,N-dimethylformamide, or any non-cyclic amide), monoalcohols (e.g., methanol, ethanol, propanol, isopropanol, benzyl alcohol), dibasic esters and derivatives thereof, alkylene carbonates (e.g., ethylene carbonate, propylene carbonate), monobasic esters (e.g., ethyl lactate, ethyl acetate), carboxylic acids (e.g., maleic acid, oleic acid, itaconic acid, acrylic acid, methacrylic acid), glycol esters, and/or surfactants (e.g., alkylbenzenesulfonates, lignin sulfonates, alkylphenol ethoxylates, polyalkoxylated amines) and combinations thereof. Further co-solvents, including but not limited to, liquid amides, 2-pyrrolidone, N-alkyl 2-pyrrolidones, and non-ionic surfactants (e.g., alkylaryl polyether alcohols) can be used in certain embodiments.

Various other additives that do not negatively impact the formation of the adducts disclosed herein can be included in the reaction mixture (i.e., urease inhibitor(s), urea, formaldehyde, and optional solvent(s)). For example, components (e.g., impurities) that are generally present in urea and/or formaldehyde are commonly incorporated in the reaction mixture. In some embodiments, components that are desirably included in the final product can be incorporated into the reaction mixture (e.g., dyes, as described in further detail below).

In certain embodiments, monoammonium phosphate (MAP), diammonium phosphate DAP), and/or ammonium sulfate (AS) can be used to promote the formation of adducts. Although not intended to be limiting, it is believed that MAP, DAP, or AS can function as catalysts to facilitate the formation of the adducts disclosed herein. In some embodiments, it may be possible, by including MAP, DAP, and/or AS (and/or other catalysts), to reduce the reaction time and/or to conduct the reaction at lower temperatures than would otherwise be required to form the adducts. In certain embodiments, mixing granules of NBPT-treated urea with granules of MAP, DAP or AS also accelerates formation of the adducts disclosed herein as compared with embodiments wherein no catalyst is employed. In some embodiments, the use of a particular catalyst may have an effect on the amount and/or type(s) of various adducts formed during the reaction.

Adduct formation can be conducted at various pH values, and in some embodiments, it may be desirable to adjust the pH of the reaction mixture (e.g., by adding acid and/or base). Representative acids include, but are not limited to, solutions of mineral acids such as hydrochloric acid, sulfuric acid, nitric acid, phosphoric acid, and combinations thereof. Exemplary bases include, but are not limited to, solutions of ammonia, amines (e.g., primary, secondary and tertiary amines and polyamines), sodium hydroxide, potassium hydroxide, and combinations thereof. In some embodiments, it may be desirable to employ a buffer solution to control the pH of the reaction mixture. Representative buffer solutions include, but are not limited to, solutions of triethanolamine, sodium borate, potassium bicarbonate, sodium carbonate, and combinations thereof.

The conditions under which the urease inhibitor (e.g., NBPT), urea, and formaldehyde (and optionally, other additives) are combined can vary. For example, the reaction can be conducted at various temperatures, e.g., ranging from ambient temperature (about 25° C.) to elevated temperatures (above 25° C.). In certain embodiments, the temperature at which the reaction is conducted is at least about 50° C., at least about 60° C., at least about 70° C., at least about 80° C., at least about 90° C., or at least about 100° C., such as about 20° C. to about 150° C.

Advantageously, in some embodiments, the reaction product can be prepared under conditions of conventional urea manufacturing (as described, for example, in Jozeef Meesen, Ullman's Encyclopedia of Industrial Chemistry (2012), vol. 37, pages 657-695, which is incorporated herein by reference). Such urea manufacturing conditions generally include temperatures at which urea is in molten form, e.g., temperatures of about 130° C. to about 135° C. For example, in such embodiments, the NBPT can be added to a molten mixture of urea and formaldehyde (or urea and urea-formaldehyde (i.e., UF, UFC or UFP)). The mixture can be combined and then cooled to provide a reaction product comprising the reaction product, i.e., adduct of NBPT, urea, and formaldehyde. For example, the composition can be cooled by subjecting the reaction mixture to typical urea pastillation, prilling or granulation processes (e.g., fluidized bed granulation, drum granulation, sprouted bed granulation, and the like), which generally comprise a cooling step following formation of pastilles, prills and/or granules. Generally, the drying process provides the reaction product in the form of a solid material (e.g., a pastillated, granular or prilled solid).

The NBPT, urea, and formaldehyde (i.e., the reaction mixture) can be maintained together under the reaction conditions for various periods of time. For example, in some embodiments, the reaction can be conducted within a relatively short period (e.g., on the order of minutes, e.g., about 30 seconds to about 30 minutes, about 1 to about 20 minutes, or about 1 to about 10 minutes. In some embodiments, the reaction may be conducted for about 1 minute or longer, about 2 minutes or longer, about 5 minutes or longer, about 10 minutes or longer, about 15 minutes or longer, or about 20 minutes or longer. In certain embodiments, the reaction can be conducted for about 2 hours or less, about 1 hour or less, about 30 minutes or less, about 25 minutes or less, about 20 minutes or less, about 15 minutes or less, or about 10 minutes or less. In some embodiments, the components can be reacted together for a somewhat longer period, e.g., for a period of about 2 hours or longer, about 4 hours or longer, about 6 hours or longer, about 8 hours or longer, about 10 hours or longer, about 12 hours or longer, about 14 hours or longer, about 16 hours or longer, about 18 hours or longer, about 20 hours or longer, about 22 hours or longer, or about 24 hours or longer. In some embodiments, the reaction time is about 2 hours to about 48 hours, such as about 4 hours to about 36 hours.

In certain embodiments, the amount of time for which the reaction is conducted may be that amount of time required to convert a given percentage of urease inhibitor (e.g., NBPT) in the reaction mixture to adduct form. For example, in one embodiment, the reaction mixture is reacted to about 10% or less free (i.e., unreacted) urease inhibitor (e.g., NBPT) by weight, based on total urease inhibitor added to the reaction mixture or to about 5% or less free urease inhibitor (e.g., NBPT) by weight, based on total urease inhibitor added to the reaction mixture. In another embodiment, the reaction mixture is reacted to about 40% or less free (i.e., unreacted) urease inhibitor by weight, based on the total urease inhibitor added to the reaction mixture, or to about 30% or less free urease inhibitor by weight, based on total urease inhibitor added to the reaction mixture, or to about 20% or less free urease inhibitor by weight, based on total urease inhibitor added to the reaction mixture. In yet another embodiment, the reaction mixture is reacted to about 2% or less free urease inhibitor by weight, based on total urease inhibitor added to the reaction mixture, or to about 1% or less free urease inhibitor by weight, based on total urease inhibitor added to the reaction mixture, or to about 0.1% or less free urease inhibitor by weight, based on total urease inhibitor added to the reaction mixture. In a further embodiment, the reaction mixture is reacted to about 50% (i.e. unreacted) urease inhibitor by weight, based on the total urease inhibitor added to the reaction mixture to create a 1:1 wt. % adduct: free urease inhibitor product (as measured by phosphorous content). In yet a further embodiment, the reaction mixture is reacted to create a weight ratio of adduct:free urease inhibitor product in the range from about 4:1 to 1:4 (as measured by phosphorous content), including 3:1 to 1:3, 2:1 to 1:2, and a 1:1. Accordingly, in some embodiments, the method of producing an adduct as described herein further comprises monitoring the amount of free urease inhibitor (e.g., NBPT) remaining over the course of the reaction and evaluating the completeness of reaction based on the amount of free urease inhibitor (e.g., NBPT) in comparison to the desired maximum content of free urease inhibitor (e.g., NBPT) by weight to be included in the reaction product.

It is noted that the particular reaction components may affect the reaction conditions required to produce the reaction product. For example, reaction of components in one solvent may be more efficient than reaction of those components in a different solvent and it is understood that, accordingly, less time and/or lower temperature may be required for adduct formation in the former case. Also, where a catalyst is employed, less time and/or lower temperature may be required for adduct formation. It is also noted that, in some embodiments, employing different reaction conditions can have an effect on the amount and/or type(s) of various adducts formed during the reaction.

The reaction products provided according to the methods disclosed hereinabove can comprise one or a plurality of structurally different adducts. For example, a given reaction product can comprise at least one adduct, at least two different adducts, at least three different adducts, at least four different adducts, at least five different adducts, at least ten different adducts, at least twenty-five different adducts, at least about fifty different adducts, or at least about one hundred different adducts. The adducts may be in the form of discrete compounds, oligomers, polymers, and combinations thereof. The overall amount of adduct formed can vary and, likewise, the amount of each different adduct (where more than one adduct is present in the composition) can vary.

Certain representative adducts that have been identified in reaction products, based on reactions between urea, formaldehyde, and urease inhibitor (e.g., NBPT), are as follows (wherein the reference to these adducts as “Adduct 1,” “Adduct 2,” and “Adduct 3” are arbitrary names chosen to distinguish them from one another and from other adducts that may be present in various reaction products):

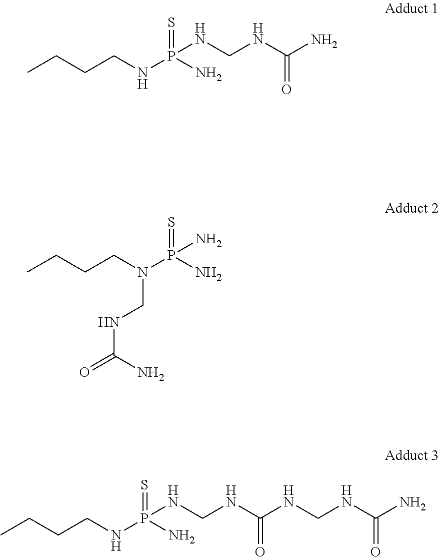 [SMILES: CCCCNP(N)(=S)NCNC(N)=O ; CCCCN(CNC(N)=O)P(N)(N)=S ; CCCCNP(N)(=S)NCNC(=O)NCNC(N)=O]

Further, one or more adduct dimers based on the reaction between NBPT, urea and formaldehyde have been identified, wherein the one or more adduct dimers are represented by the following structure:

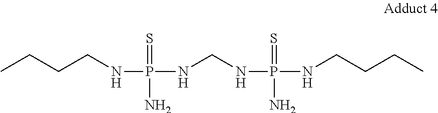 [SMILES: CCCCNP(N)(=S)NCNP(N)(=S)NCCCC]

The reaction product can comprise various other components in addition to the adduct(s). It is to be understood that other components that may be present in the reaction product can be a result of the specific method used to produce the reaction product and, particularly, of the amount of each reactant included in the reaction mixture. For example, where the reaction conditions are such that there is an excess of one or two reactants, the reaction product may comprise free reactant (i.e., reactant which is not incorporated into an adduct). In various embodiments, the reaction product can comprise at least some percent by weight of one or more components selected from the group consisting of free urease inhibitor (e.g., NBPT), free formaldehyde, free urea, free urea-formaldehyde products (e.g., UFP), catalyst (e.g., MAP, DAP, or AS), impurities (e.g., arising from the grade of reactants used), solvent, water, and combinations thereof. The relative amounts of such components can vary, with exemplary amounts and ratios disclosed below.

The reaction products disclosed herein can include widely varying mole percentages of urea, formaldehyde, and urease inhibitor (e.g., NBPT) (including complexed and free forms of each component, e.g., as determined by elemental analysis). Similarly, the reaction products disclosed herein can have widely varying molar ratios, particularly as the method of producing the adduct-containing compositions can vary. In some specific embodiments, the reaction products can have a molar ratio of about 1:0.5 to about 1:2 urease inhibitor (e.g., NBPT):urea (including complexed and free forms of each component, e.g., as determined by elemental analysis). In certain embodiments, urea is used in great excess with respect to the urease inhibitor (e.g., NBPT); consequently, in such embodiments, the molar ratio of urease inhibitor (e.g., NBPT): urea is significantly lower. In some specific embodiments, the reaction products can have a molar ratio of about 1:0.5 to about 1:2 urease inhibitor (e.g., NBPT):formaldehyde (including complexed and free forms of each component, e.g., as determined by elemental analysis). Again, in some embodiments, the formaldehyde is present in significant excess with respect to the urease inhibitor (e.g., NBPT) and, in such embodiments, the molar ratio of urease inhibitor (e.g., NBPT):formaldehyde is significantly lower.

The reaction product obtained according to the methods disclosed herein can be used directly or stored for later inclusion within the acidic fertilizer-containing compositions disclosed herein. For example, the reaction product can be used or stored for later use in the form in which it is provided, can be treated in some manner before being used or stored for later use (e.g., to provide it in a different form or to isolate one or more components therefrom), and/or can be combined with other components before being used or stored for later use. Various compositions comprising at least a portion of the reaction products disclosed herein are disclosed herein below.

For example, in one embodiment, the reaction product is maintained substantially in the form in which it is provided following reaction (e.g., in undiluted liquid or solid form, in solution form, in suspension/dispersion form, in the form of urea-based granules comprising the adduct, and the like). As noted above, such forms can, in some embodiments, comprise other components, e.g., residual reactants and/or solvent. The specific form of these as-formed reaction products may, in certain embodiments, be further modified prior to use and/or storage, e.g., by concentrating solution or suspension/dispersion forms by removing solvent therefrom, by diluting any of the forms by adding one or more solvents thereto, by solubilizing solid forms, or by contacting a solid, undiluted liquid, solution, or suspension/dispersion form with a solid support so as to provide the reaction product in solid form. In one particular embodiment, the reaction product is provided in homogenous solution form.

In another embodiment, the reaction product is treated so as to isolate one or more adducts therefrom and these one or more adducts can be incorporated (immediately or after storage) into an acidic fertilizer-containing composition as disclosed herein. For example, the reaction product can be treated so as to remove any or all components other than the adducts from the reaction product to obtain a mixture comprising all adducts, a mixture comprising some adducts, or one or more single, isolated adducts. Such isolated mixtures or single adducts can be provided in their natural forms (e.g., in solid or liquid, substantially pure form) or can be treated as described with regard to the as-formed reaction products modified prior to use or storage (e.g., to provide a solution or suspension/dispersion of the adduct or adducts by adding one or more solvents thereto, or to provide an adduct or adduct mixture in solid form by contacting the adduct or adduct mixture in solid, undiluted liquid, solution, or suspension/dispersion form with a solid support).

In a further embodiment, the reaction product (as-formed, or modified as noted above) or the isolated adduct(s) (as-provided, or modified as noted above) can be combined with one or more other components. For example, certain compositions are provided which comprise the reaction product admixed with one or more other components, e.g., one or more nitrogen sources (e.g., urea or a urea formaldehyde product) or free urease inhibitor (e.g., NBPT). Certain compositions are provided which comprise the one or more isolated adducts admixed with one or more other components, e.g., one or more nitrogen sources (e.g., urea or a urea formaldehyde product) or free urease inhibitor (e.g., NBPT). In some embodiments, compositions comprising at least one urease inhibitor adduct containing a urea source are provided. Again, any of these combinations can be in varying forms (e.g., in solid form, undiluted liquid form, solution form, dispersion/suspension form, and the like) and can be maintained in storage and used directly in combination with an acidic fertilizer, as described herein.

### Compositions Comprising a Urease Inhibitor Adduct and an Acidic Fertilizer

In various embodiments of the present invention, the urease inhibitor adducts described above can be employed in a fertilizer composition and, in particular, can be employed in a fertilizer composition including one or more acidic fertilizers. Although fertilizers comprising different nutrients may be applied to soils or plants separately, it may be beneficial to prepare, package, transport, store and/or use a single fertilizer composition. However, some fertilizers are generally understood to be incompatible with urease inhibitor-containing compositions. For example, as referenced herein above, although N-alkyl phosphoric triamide or N-alkyl thiophosphoric triamide such as NBPT is reasonably stable under normal storage conditions such as room temperature and neutral pH, it is well known that acidic conditions may lead to rapid disappearance of NBPT. See, for example, Apparent persistence of N-(n-butyl) thiophosphoric triamide is greater in alkaline soils, Engel et al., Soil Science Society of America Journal (2013), 77(4), 1424-1429. As such, the storage life for certain urease inhibitors such as NBPT could be substantially shortened in acidic conditions when urease inhibitor-containing urea fertilizer granules are blended with an acidic fertilizer. It has been previously observed that a urease inhibitor such as NBPT may decompose almost completely within 1-2 weeks after the blending of NBPT-containing urea and one or more acidic fertilizers.

Surprisingly, the inclusion of certain basic components within compositions comprising a urease inhibitor adduct as disclosed herein and one or more acidic fertilizers provides unexpected stability for the urease inhibitor. By using a basic component within such compositions, the present disclosure provides novel economic and acid resistant urease inhibitor-containing fertilizer compositions that may provide longer storage life for an acid sensitive urease inhibitor such as NBPT.

According to the present disclosure, at least a portion of the urease inhibitor in the urease inhibiting acidic fertilizer-containing composition is provided in the form of one or more urease inhibitor adducts, as described above. The urease inhibitor adduct(s) are typically incorporated within the acidic fertilizer-containing composition in the form of a urease inhibitor adduct-containing urea source. As such, the urease inhibitor adduct-containing urea source can comprise the reaction product comprising one or more adducts formed from a urease inhibitor, urea, and/or formaldehyde, as described above and urea. Where an excess of urea is used to produce the adducts, the reaction product can be directly used as the urease inhibitor adduct-containing urea source. In some embodiments, urea is added to the reaction product to provide the urease inhibitor adduct-containing urea source. The urea can include any of the types of urea disclosed hereinabove, such as free urea, urea-formaldehyde products, urea ammonium nitrate, and the like and additionally can include various substituted ureas. Another suitable urea source can be or can include animal waste(s) such as urine and/or manure produced by one or more animals, e.g., cows, sheep, chickens, buffalo, turkeys, goats, pigs, horses, and the like.

The relative amounts of adduct and urea in the urease inhibitor adduct-containing urea source used in the present invention can vary. In certain embodiments, the amount of adduct can be, for example, within the range of about 1 ppm to about 10,000 ppm adduct in the urease inhibitor adduct-containing urea source. A composition provided by combining the reaction product (as described above) with urea (or a composition provided by preparing the reaction product with a sufficient excess of urea) can provide a urease inhibitor adduct-containing urea source comprising up to about 95% by weight urea, up to about 98% by weight urea, up to about 99% by weight urea, up to about 99.5% by weight urea or up to about 99.9% by weight urea, e.g., between about 95% and about 99.9% by weight urea, between about 98% and about 99.9% by weight urea, or between about 99% and about 99.9% by weight urea, and the like.

Where a reaction product (and/or isolated urease inhibitor adduct(s)) is combined with urea, it can be blended directly with granulated urea or can be used as an additive to liquid (molten) urea. The combining of the reaction product (as described above) and/or isolated urease inhibitor adduct(s) with urea can be done at ambient temperature or at elevated temperature, e.g., at least about 50° C., at least about 60° C., at least about 70° C., at least about 80° C., at least about 90° C., or at least about 100° C., such as about 20° C. to about 150° C. Advantageously, in some embodiments, the reaction product and/or isolated urease inhibitor adduct(s) can be combined with urea under conditions of conventional urea manufacturing generally including temperatures at which urea is in molten form, e.g., temperatures of about 130° C. to about 135° C. In such embodiments, it is beneficial to ensure that sufficient mixing is employed during this combining step so that the adduct is substantially homogeneously distributed within the molten urea, particularly before the urea melt cools and solidifies in the subsequent granulation step.

The reaction product and/or isolated urease inhibitor adduct(s) can be combined with the urea in various forms, e.g., in liquid form, as a solution or suspension/dispersion, or in solid form. The amount of reaction product and/or isolated urease inhibitor adduct(s) added to urea in accordance with this embodiment depends on the desired adduct content of the resulting urease inhibiting acidic fertilizer composition and on the adduct content of the reaction product, and can be readily calculated by those skilled in the art.

In any embodiment in the present disclosure, the acidic fertilizer may be any fertilizer composition comprising an acidic component. The acidic fertilizer may provide a pH value lower than 7 when it is dissolved or partially dissolved in water. An acidic fertilizer in the present disclosure may include any material that comprises any form of phosphate or sulfate. For example, phosphate may include any material comprising any form of PO₄³⁻, HPO₄²⁻, H₂PO₄²⁻, H₃PO₄, or any combination thereof Sulfate may include any material comprising any form of SO₄²⁻, HSO₄⁻, H₂SO₄, or any combination thereof. An acidic fertilizer in the present disclosure may be selected from, but is not limited to, monoammonium phosphate (MAP), diammonium phosphate (DAP), ammonium sulfate (AS), ammonium hydrogensulfate, rock phosphate, super phosphate, serpentine super phosphate, reactive phosphate rock, NPSZ, Micro-Essentials SZ (MESZ (12-40-0-10S-1Zn), triple super phosphate, struvite, or any combination thereof. In certain embodiments, the particulate acidic fertilizer is selected from MAP, DAP or AS.

In various embodiments, a basic component can be applied to the acidic fertilizer before formation of the urease inhibiting acidic fertilizer compositions disclosed herein. In some embodiments, a basic component can be applied to the urease inhibitor adduct-containing urea source before formation of the urease inhibiting acidic fertilizer compositions disclosed herein. In certain embodiments, a base component can be independently applied to both the urease inhibitor-containing urea source and the acidic fertilizer(s) of the compositions of the present invention. This application can occur before and/or after the components are combined to produce the urease inhibiting acidic fertilizer compositions. Furthermore, it is noted that at least one of the urease inhibitor adduct-containing urea source and the acidic fertilizer(s) is advantageously in particulate form such that the basic component can be applied to the surface of the particles. The various basic component-treated components can each independently provide improved storage life of the as-formed urease inhibiting acidic fertilizer compositions.

“Basic component treated”, “treated with a basic component”, or any term referring to the manner of the treatment on the surface of a particulate acidic fertilizer or a particulate urease inhibitor adduct-containing urea source in the present disclosure means that a suitable basic component is added and adhered onto the surface of either the particulate acidic fertilizer or the particulate urease inhibitor-containing urea source to provide sufficient protection for a urease inhibitor such as NBPT. Although it is desirable to cover as much surface of the acidic fertilizer in particulate form and/or the urease inhibitor adduct-containing urea source in particulate form as possible with a suitable basic component, as long as the urease inhibitor (e.g., NBPT) is sufficiently protected or the decomposition rate of the urease inhibitor (e.g., NBPT) is sufficiently slowed down, the actual percentage of the covered surface of the one or more components treated with a basic component may vary from 10% to 100%, 20% to 100%, 30% to 100%,40% to 100%, 50% to 100%, 60% to 100%. 70% to 100%, 80% to 100%, 90% to 100%, or 95% to 100%. The percentage of the covered surface in the present disclosure primarily means the percentage of the visible outer surface of the particulate particles instead of the total surface area that may include the surface area of small pores within the particulate particles.

“Half-life storage time” or “half-life” of a urease inhibitor such as NBPT in the present disclosure means the amount of time required for the amount of urease inhibitor such as NBPT to decrease to half of its initial value prior to the blending of the particulate acidic fertilizer and the particulate urease inhibitor-containing urea source. The urease inhibitor content can be analyzed by high pressure liquid chromatography (HPLC), for example, which is known to those skilled in the art.

In any embodiment in the present disclosure, the basic component may be any suitable substance that can accept hydrogen ions (protons) released from an acidic fertilizer. In various embodiments of the present invention, a basic component may be an organic carboxylic acid alternative or a sulfonic acid salt according to the following general formula (II):

R¹(X⁻)ₙMⁿ⁺ (II)

wherein R¹ is independently hydrogen, substituted or non-substituted C₁-C₃₀ straight or branched alkyl, substituted or non-substituted C₁-C₃₀ straight or branched alkenyl, substituted or non-substituted C₃-C₈ cycloalkyl, or substituted or non-substituted C₅-C₆ aromatic carbon or heterocyclic ring; (X⁻) is (COO⁻) or (SO₃⁻); Mⁿ⁺ is a metal ion, wherein the metal is Li, Na, K, Rb, Cs, Mg, Ca, Sr, Ba, Ra, Al, Mn, Fe, Co, Cu, or Zn; and n is 1, 2, 3, or 4.

In some embodiments, the carboxylic acid or sulfonic acid salt has a structure according to Formula (II) wherein R¹ is independently hydrogen, substituted or non-substituted C₈-C₂₀ straight or branched alkyl, substituted or non-substituted C₈-C₂₀ straight or branched alkenyl, substituted or non-substituted C₃-C₆ cycloalkyl, or substituted or non-substituted benzene ring; Mⁿ⁺ is a metal ion, wherein the metal is Mg, Ca, or Al; and n is 1, 2, or 3. In another aspect, the carboxylic acid or sulfonic acid salt according to Formula (II) is a stearate, wherein the metal is Mg, Ca, or Al; and n is 2 or 3.

In various embodiments, the basic component may be a metal oxide, metal hydroxide, metal alkoxide with C₁-C₃₀ straight or branched carbon chain, metal sulfate, metal bisulfate, metal carbonate, or metal bicarbonate, wherein the metal is Li, Na, K, Rb, Cs, Mg, Ca, Sr, Ba, Ra, Al, Mn, Fe, Co, Cu, or Zn. In another aspect, the basic component is MgO, Mg(OH)₂, CaO, Ca(OH)₂, Al₂O₃, Al(OH)₃, or lime (which is a calcium-containing inorganic material in which carbonates, oxides and hydroxides predominate). In certain embodiments of the present invention, the basic component is MgO.

In some embodiments, a basic component may be an amine compound, which is a primary, secondary, or tertiary, straight or branched hydrocarbon amine. The hydrocarbon is C₁-C₃₀ straight or branched alkyl, C₁-C₃₀ straight or branched alkenyl, C₃-C₈ cycloalkyl, or benzene ring, wherein the hydrocarbon is optionally substituted with hydroxyl, amino, or [(—NH)(CH₂CH₂)]ₓNH₂, wherein x is 1, 2, 3, or 4. In another aspect, the amine compound is triethylenetetramine (TETA), triethylamine (TEA), monoethanolamine (MEA), diethanolamine , triethanolamine, or aniline.

In some embodiments, the basic component in the present disclosure is a solid that can sufficiently adhere to the surface of a particulate acidic fertilizer and/or to the surface of a particulate urease inhibitor adduct-containing urea source. In some embodiments, the basic component in the present disclosure is a liquid that can provide a coating layer on the surface of a particulate acidic fertilizer and/or to the surface of a particulate urease inhibitor adduct-containing urea source.

In any embodiment of the present disclosure, the weight percentage range of the basic component associated with a basic component-treated particulate urease inhibitor adduct-containing urea source or a basic component-treated particulate acidic fertilizer composition is 0.001% to 20% by weight of the total weight of the basic component-treated particulate urease inhibitor adduct-containing urea source or the basic component-treated particulate acidic fertilizer. In one aspect, the weight percentage range is 0.1% to 5% by weight. In one aspect, the weight percentage range is 0.2% to 2% by weight. In another aspect, the weight percentage range is 0.25% to 1% by weight.

In one embodiment, the present disclosure provides a basic component-treated acidic fertilizer composition comprising a basic component and a particulate acidic fertilizer, wherein at least some of the particles (including embodiments wherein all of the particles) of the particulate acidic fertilizer have a surface which is treated with the basic component. In various embodiments, the basic component is MgO and the acidic fertilizer is selected from the group consisting of MAP, DAP, AS, NPSZ, MESZ, and any combination thereof. In some embodiments, the weight percentage range of MgO is 0.001% to 20% by weight and the weight percentage range of MAP, DAP, AS, NPSZ, MESZ, or any combination thereof is 80% to 99.999% by weight. In one aspect, the weight percentage range of MgO is 0.1% to 5% by weight and the weight percentage range of MAP, DAP, AS, NPSZ, MESZ, or any combination thereof is 99.9% to 95% by weight. In one aspect, the weight percentage range of Mg0 is 0.2% to 2% by weight and the weight percentage range of MAP, DAP, AS, NPSZ, MESZ, or any combination thereof 99.8% to 98% by weight. In one aspect, the weight percentage range of MgO is 0.25% to 1% by weight and the weight percentage range of MAP, DAP, AS, NPSZ, MESZ, or any combination thereof is 99.75% to 99% by weight.

In one embodiment, the present disclosure provides a basic component-treated urease inhibitor adduct-containing urea source composition comprising MgO and a particulate NBPT-containing urea source, wherein each of the particles of the particulate NBPT-containing urea source have a surface which is treated with MgO. In some embodiments, the percentage range of MgO is 0.001% to 20% by weight and the weight percentage range of the particulate NBPT-containing urea source is 80% to 99.999% by weight. In one aspect, the weight percentage range of MgO is 0.1% to 5% by weight and the weight percentage range of the particulate NBPT-containing urea source is 99.9% to 95% by weight. In one aspect, the weight percentage range of MgO is 0.2% to 2% by weight and the weight percentage range of the particulate NBPT-containing urea source is 99.8% to 98% by weight. In one aspect, the weight percentage range of MgO is 0.25% to 1% by weight and the weight percentage range of the particulate NBPT-containing urea source is 99.75% to 99% by weight.

In one embodiment, the present disclosure provides a method of making a basic component-treated particulate acidic fertilizer composition comprising providing a particulate acidic fertilizer having a surface; and contacting the basic component with the surface of the particulate acidic fertilizer. In another embodiment, the present disclosure also provides a method of making a basic component-treated particulate urease inhibitor adduct-containing urea source composition comprising providing a particulate urease inhibitor adduct-containing urea source having a surface; and contacting a basic component with the surface of the particulate urease inhibitor adduct-containing urea source.

In some embodiments, the present disclosure provides a method of making an urease inhibiting acidic fertilizer composition comprising: i) a particulate acidic fertilizer having a surface; ii) a particulate urease inhibitor adduct-containing urea source having a surface; and iii) a basic component, said method comprising contacting the basic component iii) with the surface of i) and blending the basic component-treated i) with ii); or contacting the basic component iii) with the surface of ii) and blending the basic component treated-ii) with i); or contacting the basic component iii) with the surface of i) and the surface of ii) independently, and blending the basic component-treated i) with the basic component-treated ii).

In any embodiment of the present disclosure, a basic component-treated particulate acidic fertilizer and/or a basic component-treated particulate urease inhibitor adduct-containing urea source may provide 14-1500, 28-1500, 60-1500, or 90-1500 days of urease inhibitor (e.g., NBPT) half-life under accelerated urease inhibitor stability lab test condition from the time when the particulate acidic fertilizer and the particulate urease inhibitor adduct-containing urea source are blended. In one aspect, a particulate acidic fertilizer and/or a particulate urease inhibitor adduct-containing urea source with its surface treated with a suitable basic component may provide 14-1000, 28-1000, 60-1000, or 90-1000 days of urease inhibitor (e.g., NBPT) half-life under accelerated urease inhibitor stability lab test condition from the time when the particulate acidic fertilizer and the particulate urease inhibitor adduct-containing urea source are blended. In another aspect, a particulate acidic fertilizer and/or a particulate urease inhibitor adduct-containing urea source with its surface treated with a suitable basic component may provide 14-500, 28-500, 60-500, or 90-500 days of urease inhibitor (e.g., NBPT) half-life under accelerated urease inhibitor stability lab test condition from the time when the particulate acidic fertilizer and the particulate urease inhibitor adduct-containing urea source are blended. In another aspect, a particulate acidic fertilizer and/or a particulate urease inhibitor adduct-containing urea source with its surface treated with a suitable basic component may provide 14-250, 28-250, 60-250, or 90-250 days of urease inhibitor (e.g., NBPT) half-life under accelerated urease inhibitor stability lab test condition from the time when the particulate acidic fertilizer and the particulate urease inhibitor-containing urea source are blended.

In any embodiment of the present disclosure, a particulate acidic fertilizer and/or a particulate urease inhibitor adduct-containing urea source with its surface treated with a suitable basic component may provide 25% to 1000%, 50% to 1000%, 75% to 1000%, or 100%-1000% improvement of the urease inhibitor (e.g., NBPT) half-life storage time compared to a particulate acidic fertilizer or a particulate urease inhibitor adduct-containing urea source that is not treated with a basic material. Those skilled in the art will appreciate that different acidic fertilizers may have very different acidity. The stronger the acidity, the shorter the urease inhibitor (e.g., NBPT) half-life storage may be observed.

In any embodiment in the present disclosure, any basic component-treated acidic fertilizer composition and/or basic component-treated urease inhibitor adduct-containing urea source may be treated with at least one additional layer of another material that may include, but is not limited to, a petroleum product, a wax, a paraffin oil, a bitumen, an asphalt, a lubricant, a coal product, an oil, canola oil, soybean oil, coconut oil, linseed oil, tung oil, vegetable wax, animal fat, animal wax, a forest product, tall oil, modified tall oil, tall oil pitch, pine tar, a synthetic oil, a synthetic wax, a synthetic lubricant, an ethylene-vinyl acetate copolymer, an ethyleneacrylic acid copolymer, an ethylene-ethyl acrylate copolymer, an ethylene-vinyl alcohol copolymer, ethylene-vinyl, alcohol-vinyl acetate terpolymers, polyurethane polymer, alkyd resin, a surfactant, soap or a combination thereof. The at least one additional layer of another material may be applied prior to or after the treatment of a basic component to a particulate acidic fertilizer or a particulate urease inhibitor adduct-containing urea source.

In any embodiment of the present disclosure, the diameter range of the particulate acid fertilizer particles or the particulate urease inhibitor containing urea source particles is 0.1 mm to 10 mm. In one aspect, the diameter range is 0.2 to 7.5 mm. In another aspect, the diameter range is 0.5 mm to 5 mm.

In any embodiment of the present disclosure, the diameter of basic component particles may be suitable in a very wide range as far as basic component particles can adhere to the surface of either the particulate acid fertilizer or the particulate urease inhibitor containing urea source. For example, a suitable basic component such as MgO may be as small as a nanopowder, which may have less than 50 nm diameter.

In one aspect, the at least one additional layer of another material has a weight percentage range of 0.01% to 5% by weight of the total weight of the particulate fertilizer that is treated by the at least one additional layer of another material. In another aspect, the weight percentage range is 0.02% to 1.0% by weight. In another aspect, the weight percentage range is 0.04% to 0.5% by weight. In one aspect, the at least one additional layer of another material is a wax. Urease inhibiting acidic fertilizer compositions disclosed herein can broadly be used in all agricultural applications in which urea is currently used. These applications include a very wide range of crop and turf species, tillage systems, and fertilizer placement methods. The compositions disclosed herein are useful for fertilizing a wide variety of seeds and plants, including seeds used to grow crops for human consumption, for silage, or for other agricultural uses. Indeed, virtually any seed or plant can be treated in accordance with the present invention using the compositions of the present invention, such as cereals, vegetables, ornamentals, conifers, coffee, turf grasses, forages and fruits, including citrus. Plants that can be treated include grains such as barley, oats and corn, sunflower, sugar beets, rape, safflower, flax, canary grass, tomatoes, cotton seed, peanuts, soybean, wheat, rice, alfalfa, sorghum, bean, sugar cane, broccoli, cabbage and carrot. Application of a reaction product containing a significant urea concentration to soil and/or plants can increase the nitrogen uptake by plants, enhance crop yields, and minimize the loss of nitrogen from the soil.

In one aspect, the present disclosure provides that the base treated acidic fertilizer has acceptable spreader test result according to European Standard EN13739-2 for solid fertilizer distributors. In one aspect, the base treated acidic fertilizer provides a coefficient of variation value of less than 15%. In another aspect, the base treated acidic fertilizer provides a coefficient of variation value of less than 15%. In one aspect, the base treated acidic fertilizer is MgO treated MAP, DAP, or a combination thereof. In one aspect, the weight percentage of MgO in the MgO treated MAP or DAP is 0.1 to −2%. In one aspect, the weight percentage of MgO in the MgO treated MAP or DAP is 0. 2 to −1.5%.

### Other Optional Components (Applicable to all Compositions Disclosed Herein)

Other optional components may be used in compositions of the present invention. Examples of other such components include but are not limited to: nitrification inhibitors; conditioners; xanthan gum; calcium carbonate (agricultural lime) in its various forms for adding weight and/or raising the pH of acidic soils; metal containing compounds and minerals such as gypsum, metal silicates, and chelates of various micronutrient metals such as iron, zinc and manganese; talc; elemental sulfur; activated carbon, which may act as a “safener” to protect against potentially harmful chemicals in the soil; plant protectants; nutrients; nutrient stabilizers; super absorbent polymers; wicking agents; wetting agents; plant stimulants to accelerate growth; inorganic nitrogen, phosphorus, potassium (N—P—K) type fertilizers; sources of phosphorus; sources of potassium; organic fertilizers; surfactants, such as alkylaryl polyether alcohols; initiators; stabilizers; cross linkers; antioxidants; UV stabilizers; reducing agents; dyes, such as blue dye (FD & C blue #1); pesticides; herbicides; fungicides; and plasticizers. The content of the additional component(s) disclosed herein can be from about 1 to about 75 percent by weight of the composition and depends, in part, on the desired function of the additional component(s) and the makeup of the composition to which the additional component(s) are added.

Examples of conditioners include but are not limited to tricalcium phosphate, sodium bicarbonate, sodium ferricyanide, potassium ferricyanide, bone phosphate, sodium silicate, silicon dioxide, calcium silicate, talcum powder, bentonite, calcium aluminum silicate, stearic acid, and polyacrylate powder. Examples of plant protectants and nutrient stabilizers include silicon dioxide and the like. Examples of nutrients include, but are not limited to, phosphorus and potassium based nutrients. A commercially available fertilizer nutrient can include, for example, K-Fol 0-40-53, which is a solution that contains 40 wt. % phosphate and 53 wt. % potassium, which is manufactured and distributed by GBS Biosciences, LLC.

Nitrification inhibitors are compounds which inhibit the conversion of ammonium to nitrate and reduce nitrogen losses in the soil. Examples of nitrification inhibitors include, but are not limited to, dicyandiamide (DCD), and the like. Although the compositions disclosed herein can include DCD, in certain embodiments, the compositions are substantially free of DCD. “Substantially free” means that either no DCD can be detected in the mixture or, if DCD can be detected, it is (1) present in <1% w/w (preferably, <0.85% w/w, <0.80% w/w, or <0.75% w/w); and (2) does not produce effects characteristic of DCD at higher proportions. For example, a composition substantially free of DCD would not produce the environmental effects of exposure to concentrated or pure DCD even if a trace amount of DCD could be detected in the mixture. Certain exemplary compositions can have a DCD content of less than about 0.85% by weight, less than about 0.80% by weight, less than about 0.75% by weight, less than about 0.5% by weight, or less than about 0.25% by weight.

It is noted that, in some embodiments, additional free NBPT can be added to the reaction product (described above), the urea, or the combination thereof. Other components may be present in the urease inhibiting acidic fertilizer composition, which can be intentionally added or which can be inherently present in one or more of the urease inhibiting acidic fertilizer composition components. For example, the urease inhibitor adduct-containing urea source can comprise, in addition to the urea and reaction product components, some moisture, urea synthesis byproducts, solvent(s), and as noted further herein, may optionally contain other additives, such as dye(s), NBPT stabilizer(s), and/or micronutrient(s).

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

### Example 1

### Synthetic Preparation of Adducts

As a representative example, to a solution of NBPT (5.0 g, 29.90 mmol) in N-methyl 2-pyrrolidone (NMP, 25 mL), was added to ACS-grade urea (1.79 g, 29.90 mmol, 1 equiv), followed by formalin (50%, 795 μL, 29.90 mmol, 1 equiv) at room temperature. The reaction mixture was stirred for 24 h. A homogeneous solution was obtained, containing ˜10% unreacted NBPT (as evaluated by HPLC) and adducts, among other species.

TABLE 1
Adduct Formation Observed With Different Reactants and Reaction Conditions

| | | | Reaction Conditions | | | NBPT |
|---|---|---|---|---|---|---|
| | | Concentration | | | Reaction | conversion |
| Run | | of NBPT | | Temp | Time | (%, |
| # | Reactants | (wt. %) | Solvent | (° C.) | (hrs) | HPLC) |
| 1 | NBPT + HCHO | 15 | water | 25° C. | 24 | 82 |
| | 37% + ACS-U^{a} | | | | | |
| | (1:1:1) | | | | | |
| 2 | NBPT + | 13 | water | 25° C. | 24 | 98.9 |
| | dimethylolurea | | | | | |
| | (1:1) | | | | | |
| 3 | NBPT + | 13 | water | 25° C. | 144 | 99.9 |
| | dimethylolurea | | | | | |
| | (1:1) | | | | | |
| 4 | NBPT + | 13 | water | 40° C. | 24 | 96 |
| | dimethylolurea | | | | | |
| | (1:1) | | | | | |
| 5 | NBPT + | 9 | water | 40° C. | 24 | 99.2 |
| | dimethylolurea | | | | | |
| | (1:4) | | | | | |
| 6 | NBPT + reg-U^{b} | 0.027 | water | 25° C. | 24 | <1 |
| 7 | NBPT + reg-U^{b} | 0.027 | water | 25° C. | 24 | 26 |
| | | | (MAP added as | | | |
| | | | catalyst) | | | |
| 8 | NBPT + HCHO | 15 | NMP | 25° C. | 24 | 67 |
| | 50% + ACS-U^{a} | | | | | |
| | (1:0.5:1) | | | | | |
| 9 | NBPT + HCHO | 15 | propylene | 25° C. | 24 | 40 |
| | 50% + ACS-U^{a} | | glycol | | | |
| | (1:0.5:1) | | | | | |
| 10 | NBPT + HCHO | 15 | propylene | 25° C. | 24 | 55 |
| | 50% + ACS-U^{a} | | carbonate | | | |
| | (1:0.5:1) | | | | | |
| 11 | NBPT + HCHO | 15 | acetonitrile | 25° C. | 24 | 33 |
| | 50% + ACS-U^{a} | | | | | |
| | (1:0.5:1) | | | | | |
| 12 | NBPT + HCHO | 14 | NMP | 25° C. | 24 | 98.7 |
| | 50% + ACS-U^{a} | | | | | |
| | (1:1:2) | | | | | |
| 13 | NBPT + HCHO | 13 | NMP | 25° C. | 24 | 98.7 |
| | 50% + ACS-U^{a} | | | | | |
| | (1:2:2) | | | | | |
| 14 | NBPT + HCHO | 15 | NMP | 25° C. | 24 | 90 |
| | 50% + ACS-U^{a} | | | | | |
| | (1:1:1) | | | | | |
| 15 | NBPT + HCHO | 40 | NMP | 25° C. | 24 | 91 |
| | 50% + ACS-U^{a} | | | | | |
| | (1:1:1) | | | | | |
| 16 | NBPT + HCHO | 55 | NMP | 25° C. | 24 | 92 |
| | 50% + ACS-U^{a} | | | | | |
| | (1:1:1) | | | | | |
| 17 | NBPT + HCHO | 15 | NMP | 40° C. | 24 | 79 |
| | 50% + ACS-U^{a} | | | | | |
| | (1:1:1) | | | | | |
| 18 | NBPT + urea | 50 | none | 25° C. | 24 | 80 |
| | formaldehyde | | | | | |
| | concentrate | | | | | |
| | (1:1) | | | | | |
| 19 | NBPT + urea | 33 | NMP | 25° C. | 24 | 95 |
| | formaldehyde | | | | | |
| | concentrate | | | | | |
| | (1:1) | | | | | |
| 20 | NBPT + urea | 25 | NMP | 25° C. | 24 | 99 |
| | formaldehyde | | (MAP added as | | | |
| | concentrate | | catalyst) | | | |
| | (1:1) | | | | | |
| 21 | NBPT + urea | 25 | NMP/potassium | 25° C. | 24 | 99.9 |
| | formaldehyde | | phosphate | | | |
| | concentrate | | buffer pH 7 | | | |
| | (1:1) | | | | | |
| 22 | NBPT + urea | 13 | NMP | 25° C. | 24 | 99.7 |
| | formaldehyde | | | | | |
| | concentrate | | | | | |
| | (1:4) | | | | | |
| 19 | NBPT + urea | 33 | NMP | 40° C. | 24 | −100 |
| | formaldehyde | | | | | |
| | concentrate | | | | | |
| | (1:1) | | | | | |

^{a}ACS-U is ACS-grade urea, which is determined as being formaldehyde and/or UF free.
^{b}Reg-U is commercial grade urea that contains approx. 0.4 wt. % formaldehyde as UF.

### Example 2

### Analysis of Fertilizer Compositions Treated with a Basic Component

Urea samples treated with NBPT adducts were prepared by adding a mixture of AGROTAIN® ADVANCED 1.0 and a solution of NBPT adducts formed according to Example 1 to ACS grade urea in a ribbon blender (targeting 111 ppmP of active ingredients on urea), referred to herein below as NBPT adduct-containing urea. AGROTAIN®-treated urea was prepared by treating ACS grade urea with AGROTAIN® ADVANCED 1.0 (targeting 111 ppmP of NBPT on urea), referred to herein below as NBPT-containing urea. Both NBPT adduct-containing urea and A GROT AIN® ADVANCED 1.0-treated urea batches were mixed in a ribbon blender on a medium setting for 5 minutes and left to dry partially covered overnight, at room temperature.

Macronutrients (300 g) were blended with MgO via manual shaking in ajar. For the samples containing 0.25 wt. % MgO treatment rate, MgO (0.75 g) was applied on the macronutrient (300 g). For treatment rate corresponding to 0.5 wt. %, the macronutrient (300 g) was treated with MgO (1.5 g).

The 1:1 MgO:NBPT-containing adducts sample was prepared by manually mixing equal weights of MgO with a solution of NBPT-containing adducts prepared according to Example 1. The mixture MgO/adducts was then used to treat ACS grade urea (150 g) by manual shaking in a jar. MAP (150 g) was then blended with the treated sample.

Final blends of urease inhibiting acidic fertilizer compositions were prepared by manually shaking in a jar both the macronutrient (MAP, DAP, or Micro-Essentials® (ME)), with or without MgO, 150 g, with either AGROTAIN® ADVANCED 1.0 or NBPT-containing adducts (150 g), resulting in a Ill w/w mixture of macronutrient:urea.

After measured amounts of time, the particles of macronutrient were physically separated from the urea granules, which are visually different. The granules of urea treated with the urease inhibitor were submitted for HPLC. The phosphorus (P) present in the urea treated with the urease inhibitor, separated out of the various samples of final urease inhibiting acidic fertilizer compositions, was measured as a function as time.

TABLE 1
Total P (Percent Remaining) in compositions comprising NBPT in free or adduct
form and MAP treated with various levels of MgO, measured as a function of time (days)

| | | | | 0.25 | 0.5 | |
|---|---|---|---|---|---|---|
| | | 0.25 | 0.5 | wt. % | wt. % | |
| | | wt. % | wt. % | MgO- | MgO- | MgO- |
| | | MgO- | MgO- | Treated | Treated | NBPT |
| | Untreated | Treated | Treated | MAP + | MAP + | adduct- |
| | MAP + | MAP + | MAP + | NBPT- | NBPT- | containing |
| | NBPT- | NBPT- | NBPT- | Adduct- | Adduct- | urea* + |
| | containing | containing | containing | containing | containing | untreated |
| DAY | Urea | Urea | Urea | Urea | Urea | MAP |
| 0 | 100.00% | 100.00% | 100.00% | 100.00% | 100.00% | 100.00% |
| 14 | 16.98% | 77.36% | 90.57% | 92.69% | 58.78% | 127.77% |
| 28 | 3.77% | 49.06% | 49.06% | 45.79% | 69.68% | 83.39% |
| 56 | 3.77% | 20.75% | 39.62% | 41.25% | 36.69% | |

*This is a composition using a slurry containing 50 wt % MgO with 50 wt % NBPT adduct, which was applied on urea. As a result, the treated urea contained −0.4 wt % MgO. The treated urea was then blended with untreated MAP.

As illustrated in Table 1 above, all of the samples comprising MAP treated with some amount of MgO performed better in terms of total percent phosphorus remaining, initially and after extended time passed (i.e., 84 days), than the sample comprising untreated MAP. It is also noted that the sample wherein the urea granule (rather than the MAP particle) was treated with MgO (i.e., 1:1 w/w MgO:NBPT adduct) outperformed all of the other samples in terms of total percent phosphorus remaining at 14 and 28 days.

With regard to the samples comprising MAP treated with 0.5% MgO, the samples comprising NBPT adduct-containing urea had almost double the percent phosphorus remaining at 84 days as the samples comprising NBPT-containing urea. It is noted that initially (i.e., at 14 days), the samples comprising NBPT adduct-containing urea demonstrated a greater drop in the percent phosphorus remaining than the samples comprising NBPT-containing urea. However, at 28 days, the samples comprising NBPT adduct-containing urea demonstrated a higher percentage of phosphorus remaining than the samples comprising NBPT-containing urea. At 56 days, the samples comprising NBPT adduct-containing urea demonstrated a comparable percentage of phosphorus remaining to the samples comprising NBPT-containing urea.

TABLE 2
Total P (Percent Remaining) in compositions comprising NBPT in
free or adduct form and DAP treated with various levels of MgO,
measured as a function of time (days)

| | | | | 0.25% | 0.5% |
|---|---|---|---|---|---|
| | | 0.25% | 0.5% | MgO- | MgO- |
| | | MgO- | MgO- | Treated | Treated |
| | Untreated | Treated | Treated | DAP + | DAP + |
| | DAP + | DAP + | DAP + | NBPT- | NBPT- |
| | NBPT- | NBPT- | NBPT- | Adduct- | Adduct- |
| | containing | containing | containing | containing | containing |
| DAY | Urea | Urea | Urea | Urea | Urea |
| 0 | 100.00% | 100.00% | 100.00% | 100.00% | 100.00% |
| 14 | 28.30% | 86.79% | 88.68% | 64.35% | 61.11% |
| 28 | 5.66% | 64.45% | 94.34% | 46.81% | 95.10% |
| 56 | 5.66% | 35.85% | 79.25% | 64.68% | 68.27% |
| 84 | 3.44% | 15.09% | 50.94% | 23.94% | 53.52% |

As illustrated in Table 2 above, all of the samples comprising DAP treated with some amount of MgO performed better in terms of total percent phosphorus remaining, initially and after extended time passed (i.e., 84 days), than the sample comprising untreated DAP.

With regard to the samples comprising DAP treated with 0.25% MgO, after 84 days, the samples comprising NBPT adduct-containing urea performed better, in terms of total percent phosphorus remaining, than the samples comprising NBPT-containing urea. It is noted that initially (i.e., at 14 and 28 days), the samples comprising NBPT adduct-containing urea demonstrated a greater drop in the percent phosphorus remaining than the samples comprising NBPT-containing urea. However, at 56 days, the samples comprising NBPT adduct-containing urea demonstrated a higher percentage of phosphorus remaining than the samples comprising NBPT-containing urea.

With regard to the samples comprising DAP treated with 0.5% MgO, the samples comprising NBPT adduct-containing urea had approximately the same percentage of phosphorus remaining at 84 days as the samples comprising NBPT-containing urea. It is noted that initially (i.e., at 14 days), the samples comprising NBPT adduct-containing urea demonstrated a greater drop in the percent phosphorus remaining than the samples comprising NBPT-containing urea.

TABLE 3
Total P (Percent Remaining) in compositions comprising NBPT in free or adduct form
and ME treated with various levels of MgO, measured as a function of time (days)

| | | | | | 0.25% | 0.5% |
|---|---|---|---|---|---|---|
| | | 0.25% | 0.5% | | MgO- | MgO- |
| | | MgO- | MgO- | | Treated | Treated |
| | Untreated | Treated | Treated | Untreated | ME + | ME + |
| | ME + | ME + | ME + | ME + | NBPT- | NBPT- |
| | NBPT- | NBPT- | NBPT- | NBPT- | Adduct- | Adduct- |
| | containing | containing | containing | containing | containing | containing |
| DAY | Urea | Urea | Urea | Urea | Urea | Urea |
| 0 | 100.00% | 100.00% | 100.00% | 100.00% | 100.00% | 100.00% |
| 14 | 3.77% | 73.58% | 77.36% | 1.20% | 49.32% | 44.80% |
| 28 | 1.89% | 54.72% | 60.38% | 0.89% | 41.63% | 55.24% |
| 56 | 3.77% | 26.42% | 24.53% | 0.77% | 35.99% | 30.31% |
| 84 | 1.89% | 7.55% | 11.32% | 0.00% | 18.64% | 15.76% |

As illustrated in Table 3 above, all of the samples comprising Micro-Essentials® (ME) treated with some amount of MgO performed better in terms of total percent phosphorus remaining, initially and after extended time passed (i.e., 84 days), than the sample comprising untreated ME.

With regard to the samples comprising ME treated with 0.25% MgO, after 84 days, the samples comprising NBPT adduct-containing urea performed better, in terms of total percent phosphorus remaining, than the samples comprising NBPT-containing urea. It is noted that initially (i.e., at 14 and 28 days), the samples comprising NBPT adduct-containing urea demonstrated a greater drop in the percent phosphorus remaining than the samples comprising

NBPT-containing urea. However, at 56 days, the samples comprising NBPT adduct-containing urea demonstrated a higher percentage of phosphorus remaining than the samples comprising NBPT-containing urea.

With regard to the samples comprising ME treated with 0.5% MgO, after 84 days, the samples comprising NBPT adduct-containing urea performed better, in terms of total percent phosphorus remaining, than the samples comprising NBPT-containing urea. Again, it is noted that initially (i.e., at 14 and 28 days), the samples comprising NBPT adduct-containing urea demonstrated a greater drop in the percent phosphorus remaining than the samples comprising NBPT-containing urea. However, at 56 days, the samples comprising NBPT adduct-containing urea demonstrated a higher percentage of phosphorus remaining than the samples comprising NBPT-containing urea.

### Example 3

### Analysis of Untreated Fertilizer Compositions

For comparison with the samples of urease inhibiting acidic fertilizer compositions prepared in Example 2 above, samples of urease inhibiting acidic fertilizer compositions wherein the macronutrients are not blended with MgO were prepared.

Urea samples treated with NBPT adducts were prepared by adding a mixture of AGROTAIN® ADVANCED 1.0 and a solution of NBPT adducts formed according to Example 1 on ACS grade urea in ribbon blender (targeting Ill ppmP of active ingredients on urea). AGROTAIN®-treated urea was prepared by treating ACS grade urea with AGROTAIN® ADVANCED 1.0 (targeting 111 ppmP of NBPT on urea). Both NBPT-containing adducts treated urea and A GROT AIN® ADVANCED 1.0 treated urea batches were mixed in ribbon blender on a medium setting for 5 minutes and left to dry partially covered overnight, at room temperature.

Final blends of urease inhibiting acidic fertilizer compositions were prepared by manually shaking in a jar both the macronutrient (MAP or DAP), without MgO, 150 g, with either AGROTAIN® ADVANCED 1.0 or NBPT-containing adducts (150 g), resulting in a 1/1 w/w mixture of macronutrient:urea.

After measured amounts of time, the particles of macronutrient were physically separated from the urea granules, which are visually different. The granules of urea treated with the urease inhibitor were submitted for HPLC. The phosphorus present in the urea treated with the urease inhibitor, separated out of the various samples of final urease inhibiting acidic fertilizer compositions, was measured as a function as time.

TABLE 4
Total P (Percent Remaining) in compositions comprising urea treated
with NBPT in free or adduct form and untreated MAP or DAP,
measured as a function of time (days)

| | Untreated MAP | | Untreated DAP | |
|---|---|---|---|---|
| | | Untreated | | Untreated |
| | Untreated | MAP + | Untreated | DAP + |
| | MAP + | NBPT | DAP + | NBPT |
| | NBPT- | Adduct- | NBPT- | Adduct- |
| | containing | containing | containing | containing |
| DAY | Urea | Urea | Urea | Urea |
| 0 | 100.00% | 100.00% | 100.00% | 100.00% |
| 14 | 9% | 5% | 24% | 76% |
| 28 | 17% | 0% | 10% | 31% |
| 49 | — | 0% | 5% | 30% |
| 76 | — | — | 0% | 0% |
| 106 | — | — | 0% | 0% |
| 209 | — | — | — | — |

As can be seen through a comparison of the results presented in Example 2 above and the results presented in Table 4, all of the samples comprising a macronutrient (i.e., MAP, DAP, or ME) treated with some amount of MgO performed better in terms of total percent phosphorus remaining, initially and after extended time passed, than the samples comprising an untreated macronutrient.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A composition comprising:
a particulate composition comprising urea and one or more adducts of a urease inhibitor with urea, formaldehyde, or both urea and formaldehyde;
a particulate acidic fertilizer; and
a basic component.

2. The composition according to claim 1, wherein the particulate acidic fertilizer comprises a plurality of particles each having a surface, and wherein the basic component at least partially coats the surface of at least some of the plurality of particles, such that the particulate acidic fertilizer and the basic component are present in the form of a basic component-treated particulate acidic fertilizer.

3. The composition according to claim 2, wherein the weight percentage range of the basic component is 0.0001% to 20% by weight, based on the total dry weight of the basic component-treated particulate acidic fertilizer.

4. The composition according to claim 1, wherein the particulate acidic fertilizer is selected from the group consisting of monoammonium phosphate (MAP), diammonium phosphate (DAP), ammonium sulfate, and ammonium hydrogensulfate, rock phosphate, super phosphate, serpentine super phosphate, reactive phosphate rock, NPSZ, Micro-Essentials® SZ (MESZ (12-40-0-10S-1Zn)), triple super phosphate, struvite, and any combination thereof.

5. The composition according to claim 1, wherein the basic component comprises:
i) an organic carboxylic or a sulfonic acid salt according to Formula (II):
R¹(X⁻)ₙMⁿ⁺ (Formula II)
wherein R¹ is independently hydrogen, substituted or non-substituted C₁-C₃₀ straight or branched alkyl, substituted or non-substituted C₁-C₃₀ straight or branched alkenyl, substituted or non-substituted C₃-C₈ cycloalkyl, or substituted or non-substituted C₅-C₆ aromatic carbon or heterocyclic ring; (X⁻) is a (COO⁻) or (SO₃⁻); Mⁿ⁺ is a metal ion, wherein the metal is Li, Na, K, Rb, Cs, Mg, Ca, Sr, Ba, Ra, Al, Mn, Fe, Co, Cu, or Zn; and n is 1, 2, 3, or 4;
ii) a metal oxide, metal hydroxide, metal alkoxide with C₁-C₃₀ straight or branched carbon chain, metal sulfate, metal bisulfate, metal carbonate, or metal bicarbonate, wherein the metal is Li, Na, K, Rb, Cs, Mg, Ca, Sr, Ba, Ra, Al, Mn, Fe, Co, Cu, or Zn; or
iii) an amine compound, wherein the amine compound is a primary, secondary, or tertiary, straight or branched hydrocarbon amine, wherein the hydrocarbon is C₁-C₃₀ straight or branched alkyl, C₁-C₃₀ straight or branched alkenyl, C₃-C₈ cycloalkyl, or benzene ring, wherein the hydrocarbon is optionally substituted with hydroxyl, amino, or [(—NH)(CH₂CH₂)]ₓNH₂, wherein x is 1, 2, 3, or 4.

6. The composition according to claim 1, wherein the basic component is selected from the group consisting of ammonium carbonate ((NH₄)₂CO₃), lithium oxide (Li₂O), lithium hydroxide (LiOH), lithium carbonate (Li₂CO₃), barium oxide (BaO), barium hydroxide(Ba(OH)₂, barium carbonate (BaCO₃), magnesium oxide (MgO), magnesium hydroxide (Mg(OH)₂), magnesium carbonate (MgCO₃), calcium oxide (CaO), calcium hydroxide (Ca(OH)₂), calcium carbonate (CaCO₃), aluminum oxide (Al₂O₃), aluminum hydroxide (Al(OH)₃), aluminum carbonate (Al₂(CO₃)₃), sodium oxide (Na₂O), sodium hydroxide (NaOH), sodium carbonate (Na₂CO₃), potassium oxide (K₂O), potassium hydroxide (KOH), potassium carbonate (K₂CO₃), monoethanolamine (MEA), triethylenetetramine (TETA), triethylamine (TEA), triethanolamine, diethanolamine, aniline, and any combination thereof.

7. The composition according to claim 1, further comprising one or more materials selected from the group consisting of free NBPT, free formaldehyde, urea formaldehyde polymer (UFP), water, and combinations thereof.

8. The composition according to any of claim 1, wherein the urease inhibitor comprises N-(n-butyl)thiophosphoric triamide (NBPT).

9. The composition according to claim 1, wherein the composition has an increased shelf-life as compared to a shelf-life of a composition without the basic component.

10. The composition according to claim 9, wherein the increased shelf-life of the composition is about 25% to about 1000% longer than the shelf-life of the composition without the basic component.

11. The composition according to claim 9, wherein the increased shelf-life of the composition is at least 25% longer than the shelf-life of the composition without the basic component.

12. A method of enhancing shelf life of a composition comprising a urease inhibitor and an acidic fertilizer, the method comprising:
providing the urease inhibitor in the form of one or more adducts of urease inhibitor with urea, formaldehyde, or both urea and formaldehyde; and
providing the acidic fertilizer in the form of a particulate acidic fertilizer;
wherein the particulate acidic fertilizer comprises a plurality of particles each having a surface, and wherein a basic component at least partially coats the surface of at least some of the plurality of particles, such that the particulate acidic fertilizer and the basic component are present in the form of a basic component-treated particulate acidic fertilizer.

13. The method according to claim 12, wherein the weight percentage range of the basic component is 0.0001% to 20% by weight, based on the total dry weight of the basic component-treated particulate acidic fertilizer.

14. The method according to claim 12, wherein the particulate acidic fertilizer is selected from the group consisting of monoammonium phosphate (MAP), diammonium phosphate (DAP), ammonium sulfate, and ammonium hydrogensulfate, rock phosphate, super phosphate, serpentine super phosphate, reactive phosphate rock, NPSZ, Micro-Essentials® SZ (MESZ (12-40-0-10S-1Zn)), triple super phosphate, struvite, and any combination thereof.

15. The method according to claim 12, wherein the basic component comprises:
i) an organic carboxylic or a sulfonic acid salt according to Formula (II):
R¹(X⁻)ₙMⁿ⁺ (Formula II)
wherein R¹ is independently hydrogen, substituted or non-substituted C₁-C₃₀ straight or branched alkyl, substituted or non-substituted C₁-C₃₀ straight or branched alkenyl, substituted or non-substituted C₃-C₈ cycloalkyl, or substituted or non-substituted C₅-C₆ aromatic carbon or heterocyclic ring; (X⁻) is a (COO⁻) or (SO₃⁻); Mⁿ⁺ is a metal ion, wherein the metal is Li, Na, K, Rb, Cs, Mg, Ca, Sr, Ba, Ra, Al, Mn, Fe, Co, Cu, or Zn; and n is 1, 2, 3, or 4;
ii) a metal oxide, metal hydroxide, metal alkoxide with C₁-C₃₀ straight or branched carbon chain, metal sulfate, metal bisulfate, metal carbonate, or metal bicarbonate, wherein the metal is Li, Na, K, Rb, Cs, Mg, Ca, Sr, Ba, Ra, Al, Mn, Fe, Co, Cu, or Zn; or
iii) an amine compound, wherein the amine compound is a primary, secondary, or tertiary, straight or branched hydrocarbon amine, wherein the hydrocarbon is C₁-C₃₀ straight or branched alkyl, C₁-C₃₀ straight or branched alkenyl, C₃-C₈ cycloalkyl, or benzene ring, wherein the hydrocarbon is optionally substituted with hydroxyl, amino, or [(—NH)(CH₂CH₂)]ₓNH₂, wherein x is 1, 2, 3, or 4.

16. The method according to claim 12, wherein the basic component is selected from the group consisting of ammonium carbonate ((NH₄)₂CO₃), lithium oxide (Li₂O), lithium hydroxide (LiOH), lithium carbonate (Li₂CO₃), barium oxide (BaO), barium hydroxide(Ba(OH)₂, barium carbonate (BaCO₃), magnesium oxide (MgO), magnesium hydroxide (Mg(OH)₂), magnesium carbonate (MgCO₃), calcium oxide (CaO), calcium hydroxide (Ca(OH)₂), calcium carbonate (CaCO₃), aluminum oxide (Al₂O₃), aluminum hydroxide (Al(OH)₃), aluminum carbonate (Al₂(CO₃)₃), sodium oxide (Na₂O), sodium hydroxide (NaOH), sodium carbonate (Na₂CO₃), potassium oxide (K₂O), potassium hydroxide (KOH), potassium carbonate (K₂CO₃), monoethanolamine (MEA), triethylenetetramine (TETA), triethylamine (TEA), triethanolamine, diethanolamine, aniline, and any combination thereof.

17. The method according to claim 12, wherein the urease inhibitor comprises N-(n-butyl)thiophosphoric triamide (NBPT).

18. A method of making a urease inhibiting acidic fertilizer composition, the method comprising:
providing a particulate composition comprising urea and one or more adducts of a urease inhibitor with urea, formaldehyde, or both urea and formaldehyde;
treating a surface of a particulate acidic fertilizer with a basic component to form a basic-treated acidic fertilizer; and
combining the particulate composition comprising urea and one or more adducts with the basic-treated acidic fertilizer to form the urease inhibiting acidic fertilizer composition.

19. The method of claim 18, further comprising combining urea, formaldehyde, and N-(n-butyl)thiophosphoric triamide (NBPT), such that an excess of urea is present, to form the particulate composition comprising urea and one or more adducts, wherein the one or more adducts comprise one or more adducts represented by the following: 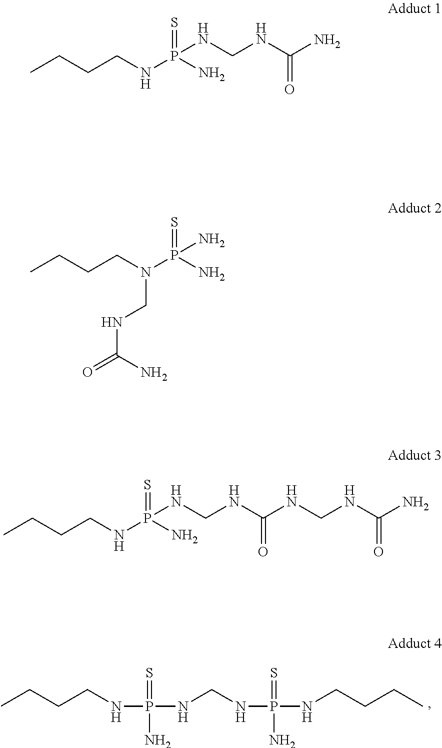 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]
which adduct or adducts remain incorporated into the excess of urea.

20. A method of fertilizing soil comprising treating soil with the composition of claim 1.
